(19) United States
(12) Patent Application Publication
(10) Pub. No.: US 2001/0015949 A1
(43) Pub. Date: Aug. 23, 2001

(54) Optical recording medium and recording-reproducing apparatus

(76) Inventors: Toshihiko Nagase, Kawasaki-shi (JP); Katsutaro Ichihara, Yokohama-shi (JP); Kazuki Matsumoto, Kawasaki-shi (JP)

Correspondence Address: PILLSBURY WINTHROP LLP, 1600 TYSONS BOULEVARD, MCLEAN, VA, 22102, US

(21) Appl. No.: 09/749,570

(22) Filed: Dec. 28, 2000

(30) Foreign Application Priority Data
Dec. 28, 1999 (JP) 11-374994
Mar. 28, 2000 (JP) 2000-089615

(51) Int. Cl. G11B 7/0037; G11B 7/24

(52) U.S. Cl. 369/100; 369/284

(57) ABSTRACT

Disclosed is an optical recording medium, including a substrate, a reflective film on the substrate, a super resolution film made of an optical material whose complex refractive index is changed in accordance with an intensity of a light irradiating the super resolution film, a first thin film interference section constituted by plural transparent thin films, the plural transparent thin films being stacked one another, each two of the plural transparent thin films adjacent to each other being different from each other in refractive index, and the super resolution film and the first thin film interference section forming a laminate structure between the substrate and the reflective film or on the reflective film, and a recording film optionally provided between the laminate structure and the reflective film. Also disclosed is a recording-reproducing apparatus having such a medium.

### CROSS-REFERENCE TO RELATED APPLICATIONS

This application is based upon and claims the benefit of priority from the prior Japanese Patent Applications No. 11-374994, filed Dec. 28, 1999; and No. 2000-089615, filed Mar. 28, 2000, the entire contents of which are incorporated herein by reference.

### BACKGROUND OF THE INVENTION

The present invention relates to an optical recording medium and a recording-reproducing apparatus, particularly, to an optical recording medium having a super resolution film and a recording-reproducing apparatus using the particular optical recording medium.

An optical disk memory capable of reproducing information or capable of recording and reproducing information by means of light-beam irradiation has excellent characteristics. For example, the optical disk memory has a large capacity, is capable of a quick-access, and capable of detachably mounting an optical disk. Therefore, the optical disk memory has already been put to a practical use as a memory device for storing various data such as voice, image, and computer data and is expected to become further pervasive.

As a technique for increasing the recording density of an optical disk, it is considered to shorten the wavelength of the gas laser used for cutting a master, to increase the numerical aperture of an objective lens, and to decrease the thickness of the substrate included in the optical disk. Further, when it comes to an optical disk capable of not only reproduction but also recording, various approaches are being studied including the mark-length recording and the land-groove recording.

In addition to the technique for increasing the recording density described above, also proposed as a technique for effectively increasing the recording density is a super resolution technology utilizing a super resolution film. The super resolution technology was originally proposed as a technology peculiar to a magneto-optical disk. Then, an attempt to reproduce at a super resolution by providing a super resolution film, whose transmittance is changed by the light irradiation, on the side of the light irradiation surface of a ROM disk was reported. In this way, it has now been proved that the super resolution technology can be applied to all the optical disks including the magneto-optical disk, a CD-ROM, a CD-R, a WORM and a phase change type optical recording medium.

The super resolution technology can be roughly classified into a heat mode type and a photon mode type. These two types differ from each other in the material forming the super resolution film.

For example, in the heat mode type, a material that changes its phase by heating is used for the super resolution film. If such a super resolution film is irradiated with a laser beam, formed is a temperature distribution in which the temperature is lowered from the center of the beam spot toward the periphery. As a result, an optical opening having a higher refractive index is formed in the portion heated to a temperature higher than the phase transition temperature of the super resolution film. It follows that it is possible to form a very small optical opening by controlling the temperature distribution of the super resolution film.

On the other hand, in the photon mode system, a photochromic material that develops color or quenches color upon irradiation with light is used for forming a super resolution film. If a photochromic material is irradiated with light having an energy higher than a predetermined value, the electron is excited from the ground level to an excited level having a short life and, then, is transited from the excited level to a metastable excited level having a very long life. As a result, the light absorption characteristics are changed. Also, in the photon mode system, there is an example that a semiconductor continuous film or a semiconductor fine particle dispersion film utilizing an absorption saturation phenomenon is used as the super resolution film.

In the case of employing any of the heat mode system and the photon mode system, the characteristics of the super resolution film are dependent on the rate of change in the optical constant (real part and/or imaginary part of the complex refractive index) of the super resolution film relative to the intensity of the irradiating light. To be more specific, with increase in the change of the optical constant, it is possible to form a large difference in reflectance between the optical opening formed within the beam spot and the optical mask portion around the optical opening, making it possible to realize an excellent reproducing performance.

However, it is practically difficult to find a material whose optical constant is greatly changed by light irradiation. As apparent from the above description, in the case of forming the super resolution film with a material whose optical constant is changed only slightly by the light irradiation, it is impossible to produce a large difference in reflectance between the optical opening and the optical mask portion. Therefore, in such a case, a read error is likely to take place. Under the circumstances, the material that can be used for forming the super resolution film is much limited in the prior art.

### BRIEF SUMMARY OF THE INVENTION

An object of the present invention is to provide an optical recording medium and a recording-reproducing apparatus capable of achieving a high recording density.

Another object of the present invention is to provide an optical recording medium and a recording-reproducing apparatus that are unlikely to cause a read error.

Still another object of the present invention is to provide an optical recording medium and a recording-reproducing apparatus that permit a material whose optical constant is changed only slightly upon irradiation with light to be used for forming the super resolution film.

According to a first aspect of the present invention, there is provided an optical recording medium, comprising a substrate, a reflective film provided on the substrate and having a recessed portion or a projecting portion as a recording mark on a surface thereof, a super resolution film made of an optical material whose complex refractive index is changed in accordance with an intensity of a light irradiating the super resolution film, and a first thin film interference section consisting of a plurality of transparent thin films, the plural transparent thin films being stacked one another, each two of the plural transparent thin films adjacent to each other being different from each other in refractive index, and the super resolution film and the first thin film interference section forming a laminate structure between the substrate and the reflective film or on the reflective film.

According to a second aspect of the present invention, there is provided an optical recording medium, comprising a substrate, a reflective film provided on the substrate, a super resolution film made of an optical material whose complex refractive index is changed in accordance with an intensity of a light irradiating the super resolution film, a first thin film interference section consisting of a plurality of transparent thin films, the plural transparent thin films being stacked one another, each two of the plural transparent thin films adjacent to each other being different from each other in refractive index, and the super resolution film and the first thin film interference section forming a laminate structure between the substrate and the reflective film or on the reflective film, and a recording film provided between the laminate structure and the reflective film.

According to a third aspect of the present invention, there is provided a recording-reproducing apparatus, comprising an optical recording medium comprising a substrate, a reflective film provided on the substrate, a super resolution film made of an optical material whose complex reflective index is changed in accordance with an intensity of a light irradiating the super resolution film, a first thin film interference section consisting of a plurality of transparent thin films, the plural transparent thin films being stacked one another, each two of the plural transparent thin films adjacent to each other being different from each other in refractive index, and the super resolution film and the first thin film interference section forming a laminate structure between the substrate and the reflective film or on the reflective film, and a recording film provided between the laminate structure and the reflective film, a recording mechanism configured to irradiate the recording film with a recording light so as to form recording marks corresponding to information to be recorded in the recording film, and a reproducing mechanism configured to irradiate the recording film with light and detect the light reflected from the optical recording medium so as to reproduce the information recorded as the recording marks in the recording film.

The term “refractive index” used without the term “complex” represents the real part of the complex refractive index. Also, the term “reflectance”, which is included in the expressions such as “reflectance of the optical recording medium” and “reflectance of the optical disk”, represents the value observed in the case where light is emitted to the optical recording medium or the optical disk from the side of the super resolution film and the thin film interference section toward the reflective film.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a cross sectional view schematically showing an optical recording medium according to one embodiment of the present invention;

FIG. 2 is a graph showing the change in the transmittance of the laminate structure formed by the thin film interference section and the super resolution film included in the optical recording medium shown in FIG. 1;

FIGS. 3A and 3B are views schematically showing the beam diameter diminishing effect achieved by the change in the transmittance shown in FIG. 2;

FIG. 4 is a view schematically showing a recording-reproducing apparatus having the optical recording medium shown in FIG. 1;

FIG. 5 is a cross sectional view schematically showing an optical recording medium according to Example 1 of the present invention;

FIG. 6 is a graph showing the relationship between the construction of the thin film interference section and the reflectance of the optical recording medium shown in FIG. 5;

FIG. 7 is a graph showing the relationship between the refractive index of the super resolution film and the reflectance of the optical recording medium shown in FIG. 5;

FIG. 8 is a graph showing the relationship between the pit length and the CNR value in respect of the optical recording medium according to Example 2 of the present invention and the optical recording medium for the comparative case;

FIG. 9 is a cross sectional view schematically showing the optical recording medium according to Example 4 of the present invention;

FIG. 10 is a graph showing the relationship between the distance between adjacent recording marks and the CNR value in respect of the optical recording medium according to Example 4 of the present invention and the optical recording medium for the comparative case;

FIG. 11 is a graph showing the effect of the thin film interference section on the reflectance of the optical recording medium according to Example 5 of the present invention;

FIG. 12 is a graph showing the relationship between the refractive index of the transparent thin film and the reflectance of the optical recording medium according to Example 6 of the present invention;

FIG. 13 is a graph showing the relationship between ΔR, which is the difference in reflectance between when the light having a low intensity is irradiated and when the light having a high intensity is irradiated, and Δn, which is the difference in refractive index between adjacent transparent thin films, in respect of the optical recording medium according to Example 6 of the present invention; and

FIG. 14 is a graph showing the relationship between the intensity of the irradiating light and the reflectance in respect of the optical recording medium according to Example 7 of the present invention.

### DETAILED DESCRIPTION OF THE INVENTION

The present invention will now be described more in detail with reference to the accompanying drawings. Throughout the drawings, the same or similar constituents are denoted by the same reference numerals so as to avoid an overlapping description.

FIG. 1 is a cross sectional view schematically showing an optical recording medium 1 according to one embodiment of the present invention. The optical recording medium 1 shown in FIG. 1 has a transparent substrate 2 and a counter substrate 7. Arranged between these transparent substrate 2 and the counter substrate 7 are a thin film interference section 3 as a first thin film interference section, a super resolution film 4, a recording film 5 and a reflective film 6, which are superposed one upon the other in the order mentioned from the side of the transparent substrate 2. In the case of reading the information recorded on the optical recording medium 1 or in the case of recording information on the optical recording medium 1, the optical recording medium 1 is irradiated with a light-beam emitted from the side of the transparent substrate 2 toward the recording film 5. It should be noted that the thin film interference section 3 has transparent thin films 3A and 3B differing from each other in the refractive index and arranged to form a laminate structure.

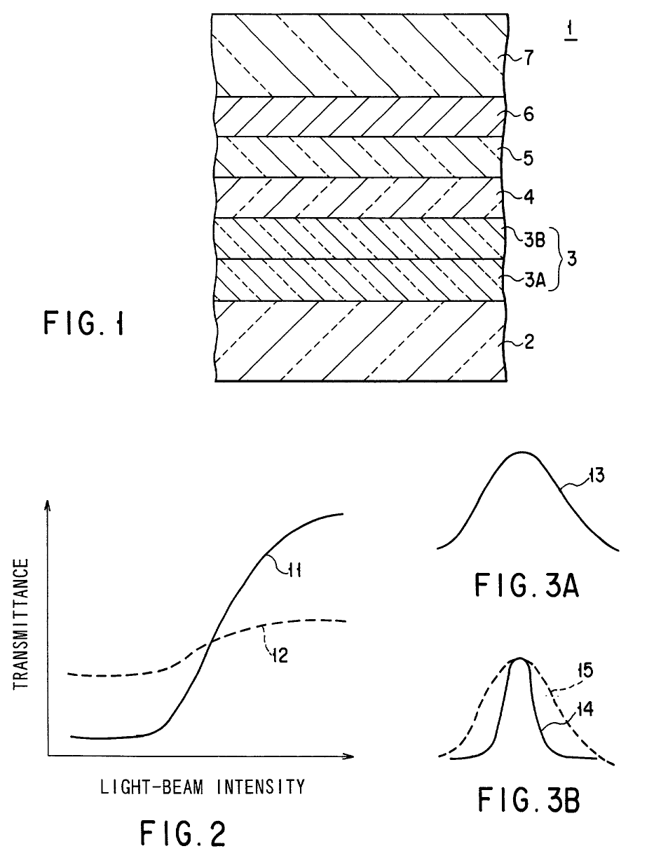

Before describing in detail the construction of the optical recording medium 1 shown in FIG. 1, the principle utilized in the optical recording medium 1 will now be described with reference to FIGS. 2, 3A and 3B.

Specifically, FIG. 2 is a graph showing the change in the transmittance of the laminate structure formed by the thin film interference section 3 and the super resolution film 4 shown in FIG. 1. In the graph, the intensity of the light-beam irradiating the laminate structure is plotted on the abscissa, with the transmittance being plotted on the ordinate. Curve 11 in the graph represents data obtained in conjunction with the laminate structure formed by the thin film interference section 3 and the super resolution film 4. On the other hand, curve 12 represents the data obtained in the case where the super resolution film 4 alone is provided without providing the thin film interference section 3.

Where the thin film interference section 3 is not provided, the change in the transmittance relative to the change in the intensity of the light-beam is very small as apparent from curve 12 shown in FIG. 2. On the other hand, where the thin film interference section 3 is provided, multiple reflection and multiple interference take place in the thin film interference section 3. Therefore, in the case of providing the thin film interference section 3, by setting appropriately the optical characteristics of the thin film interference section 3, it is possible to increase markedly the change in the transmittance relative to the change in the intensity of the light-beam as compared with the case where the thin film interference section 3 is not provided as apparent from curve 11. In other words, it is possible to amplify the characteristics of the super resolution film 4 to change the transmittance by providing the thin film interference section 3.

FIGS. 3A and 3B schematically show the beam diameter diminishing effect achieved by the change in the transmittance shown in FIG. 2. In general, a light-beam such as a laser beam has an intensity profile, which resembles the Gaussian distribution in which the temperature is lowered from the central portion toward the periphery, as denoted by curve 13 in FIG. 3A.

Where such a light-beam is allowed to be incident on the super resolution film 4 alone, the intensity profile 15 of the transmitted light is scarcely changed from the intensity profile 13 of the irradiating light as shown in FIGS. 3A and 3B because the change in the transmittance of the super resolution film 4 is small as denoted by the curve 12. In other words, a so-called “super resolution effect”, which is an effect of diminishing the beam diameter, is very small in this case.

On the other hand, where the light-beam having the intensity profile 13 shown in FIG. 3A is allowed to be incident on the laminate structure of the thin film interference section 3 and the super resolution film 4, the intensity profile 14 of the transmitted light is rendered much steeper than the intensity profile 13 of the irradiating light as shown in FIG. 3B, because the laminate structure noted above exhibits a large change in the transmittance as denoted by the curve 11 shown in FIG. 2. In other words, it is possible to obtain a very large super resolution effect, in this case.

As described above, a very large super resolution effect can be obtained in the case of providing the thin film interference section 3. It follows that the optical recording medium shown in FIG. 1 permits realizing a very high recording density as compared with the prior art. It should also be noted that, where the optical recording medium shown in FIG. 1 is made substantially equal to the conventional recording medium in the recording density, problems such as crosstalk is unlikely to take place. In other words, a failure to read information satisfactorily is unlikely to take place. It follows that it is possible to widen the operating margin of the recording-reproducing apparatus and the reproducing apparatus. Further, since the presence of the thin film interference section makes it possible to markedly increase the super resolution effect, it is possible for the super resolution film 4 to be formed of a material whose optical constant is slightly changed by the light irradiation.

The material, etc. used for preparing the members of the optical recording medium 1 shown in FIG. 1 will now be described.

Specifically, it is possible for each of the substrates 2 and 7 included in the optical recording medium 1 shown in FIG. 1 to be a resin substrate made of, for example, polycarbonate, polymethyl methacrylate and polyolefin, which is generally used in the optical disk, a substrate having a photopolymer layer formed on a glass substrate, or a transparent substrate such as a glass substrate. Incidentally, any one of the substrates 2 and 7 is an optional constituent in this embodiment. Also, a transparent substrate is used as the substrate 2 on the side of the light irradiation. However, the substrate 7 positioned on the side opposite to the light irradiation side does not necessarily require to be transparent.

It is desirable for the facing surface of at least one of these substrates 2 and 7 to have a tracking groove formed by a mastering process. Also, where the optical recording medium 1 does not include the recording film 5, i.e., where the medium 1 is read-only type, it is desirable for at least one facing surface of the substrates 2 and 7 to have pits or a tracking groove formed by a mastering process.

In the optical recording medium 1 shown in FIG. 1, it is desirable for the transparent thin films 3A and 3B collectively forming the thin film interference section 3 to be formed of a transparent material having an extinction coefficient of substantially zero, though it is possible to use a material having a small extinction coefficient in the case where the effect described above can be obtained. It is possible for each of the transparent thin films 3A and 3B to be formed of, for example, an oxide such as SiO₂, Al₂O₃, ZrO₂, and TiO₂; a fluoride such as MgF₂ and CaF₂; a nitride such as AlN and Si₃N₄; a sulfide such as ZnS; and a mixture thereof. For example, it is possible for one of the transparent thin films 3A and 3B, which has a higher refractive index, to be formed of ZrO₂, TiO₂, ZnS or ZnS.SiO₂, and for the other, which has a lower refractive index, to be formed of MgF₂, CaF₂, SiO₂, Al₂O₃, or Na₃Al₂F₆. It is also possible to use a thin film of Au, GeSi, or GeSn as each of the transparent thin films 3A and 3B if the film of Au, etc. is sufficiently thin. Further, it is possible to use a polymer film of C—H series or C—F series as each of the transparent thin films 3A and 3B.

In the optical recording medium 1 shown in FIG. 1, it is possible for the transparent thin film 3A to have a higher refractive index and for the transparent thin film 3B to have a lower refractive index. Alternatively, it is possible for the transparent thin film 3A to have a lower refractive index and for the transparent thin film 3B to have a higher refractive index. What should be noted is that it suffices for the adjacent transparent thin films 3A and 3B to be different from each other in the refractive index. Also, in the optical recording medium 1 shown in FIG. 1, the thin film interference section 3 consists of the transparent thin films 3A and 3B alone. However, it is possible for the thin film interference section 3 to be formed of three or more transparent thin films. In this case, it is possible to laminate alternately transparent thin films having a higher refractive index and transparent thin films having a lower refractive index such that a film having a higher refractive index is positioned adjacent to a film having a lower refractive index. It is also possible to laminate transparent thin films such that the refractive index is decreased or increased from the substrate 2 toward the substrate 7.

It is desirable for each of the transparent thin films 3A and 3B to meet the relationship represented by the equation given below:

dᵢ=λ/4nᵢ+m+λ/nᵢ, and

it is more desirable for each of the transparent thin films 3A and 3B to meet the relationship given below unless there is a special reason:

dᵢ=λ/4nᵢ

where dᵢ represents the thickness of each of the transparent thin films 3A and 3B, nᵢ denotes the refractive index of each of the transparent thin films 3A and 3B, λ denotes the wavelength of the irradiating light, and m denotes 0 or a natural number.

Where each of the transparent thin films 3A and 3B meets the relationship specified by the equation or equations given above, it is possible to enable the thin film interference section 3 to produce the maximum optical interference effect. Also, if the difference between the left term and the right term in each of the equations given above is within the range of about ±20%, a sufficient effect can be produced.

In the optical recording medium 1, the super resolution film 4 may be the one which changes mainly the refractive index (real part of the complex refractive index) in accordance with the intensity of the irradiating light. Alternatively, the super resolution film may be the one which changes mainly the extinction coefficient (imaginary part of the complex refractive index) in accordance with the intensity of the irradiating light. In other words, the real part n of the complex refractive index of the optical material constituting the super resolution film 4 can have a rate of change relative to the intensity of the irradiating light larger than or smaller than that of the imaginary part k of the complex refractive index of the optical material. It should be noted in this connection that the optimum value of the optical design differs depending on the factor as to which of the refractive index n or the extinction coefficient k is mainly changed.

Where the optical material constituting the super resolution film 4 is the one which changes mainly the refractive index n in accordance with the intensity of the irradiating light, it is desirable for the optical recording medium 1 to meet the relationship specified by the inequality given below:

|n₂−n₁|/n₁≦150×|R₂−R₁|/d

where n₁ denotes the refractive index of the optical material under the irradiation of light having a first intensity, n₂ denotes the refractive index of the optical material under the irradiation of light having a second intensity higher than the first intensity, d denotes the thickness (nm) of the super resolution film 4, R₁ denotes the reflectance of the optical recording medium 1 when the optical material has a refractive index n₁, and R₂ denotes the reflectance of the optical recording medium 1 when the optical material has a refractive index n₂.

Where the optical recording medium 1 meets the relationship specified in the inequality given above, it is reasonable to state that the optical recording medium 1 effectively utilizes the effect of the present invention.

Where the super resolution film 4 of the optical recording medium 1 is of the heat mode type, it is possible for the super resolution film 4 to be formed of a phase change material such as Ge—Sb—Te, Sb—Te and Sb, or a thermochromic material such as spiropyran. On the other hand, where the super resolution film 4 of the optical recording medium 1 is of the photon mode type, it is possible for the super resolution film 4 to be formed of a photochromic material such as pyrobenzopyran, fulgide, diarylethene, cyclophane, and azobenzene and an absorption saturation series material such as a semiconductor film and a semiconductor fine particle dispersion film.

It is possible to select appropriately the material of the semiconductor film or the semiconductor particles contained in the semiconductor particle dispersion film in accordance with the wavelength of the laser beam used. For example, it is possible to use a halide of Cu or Ag, a Cu oxide, AgSe, AgTe, SrTe, SrSe, CaSi, ZnS, ZnO, ZnSe, ZnTe, CdS, CdSe, CdTe, AlTe, InS, InO, InSe, InTe, AlSb, AlN, AlAs, GaN, GaP, GaAs, GaSb, GeS, GeSe, SnS, SnSe, SnTe, PbO, SiC, AsTe, AsSe, SbS, SbSe, SbTe, BiS, TiO, MnSe, MnTe, FeS, MoS, CuAlS, CuInS, CuInSe, CuInTe, AgInS, AgInSe, AgInTe, ZnSiAs, ZnGeP, CuSbS, CuAsS, AgSbS and AgAs. Also, in the case of using a semiconductor fine particle dispersion film, it is possible for the semiconductor fine particles to be dispersed in, for example, a transparent dielectric material such as SiO₂, Si₃N₄, Ta₂O₅, TiO₂ and ZnS.SiO₂, a plasma polymerization material such as C—H series and a C—F series, and C.

The optical recording medium 1 shown in FIG. 1 has the recording film 5 and, thus, is capable of both reproduction and recording. It is possible for the recording film 5 to be of the type that erase and write of information can be performed repeatedly by utilizing light such as a magneto-optical recording film of a magneto-optical recording medium or a phase change recording film of a phase change recording medium. It is also possible for the recording film 5 to be of the type that information can be written only once like a recording film using a dye. It should be noted that the recording film 5 is an optional constituent in the optical recording medium 1 shown in FIG. 1. In other words, where the optical recording medium 1 is of the read-only type, the recording film 5 is not necessary in the optical recording medium 1.

In the optical recording medium 1 shown in FIG. 1, it is possible for the reflective film 6 to be formed of, for example, a metal having a relatively high reflectance such as Al, Au, Cu and Ag, and an alloy prepared by adding Ti, Mo, Pd or Cr to the metal noted above.

In the optical recording medium shown in FIG. 1, pits as a recording marks and/or a tracking groove are formed on one main surface of the substrate 2 by the mastering process and, then, the thin film interference section 3, the super resolution film 4, the recording film 5 and the reflection 6 are formed successively on the main surface of the substrate 2 in most cases. Alternatively, it is also possible to form pits and/or a tracking groove on one main surface of the substrate 7, followed by forming successively the reflection 6, the recording film 5, the super resolution film 4 and the thin film interference section 3 on the main surface of the substrate 7 in the order mentioned.

In the optical recording medium 1, the order of laminating the thin film interference section 3, the super resolution film 4 and the recording film 5 is not particularly limited, though it is desirable to laminate the thin film interference section 3, the super resolution film 4 and the recording medium 5 in the order mentioned starting with the light irradiation side. It is also possible to laminate the super resolution film 4, the thin film interference section 3 and the recording film 5 in the order mentioned starting with the light irradiation side. Further, in the optical recording medium 1, it is possible to form a protective film on each surface of the recording film 5 in order to prevent the evaporation thereof and the like.

Where the optical recording medium 1 does not include the recording film 5, i.e., where the medium 1 is of the read-only type, it is desirable to arrange a second thin film interference section between the super resolution film 4 and the reflective film 6. The presence of the second thin film interference section makes it possible to achieve a further optimization of the optical response.

On the other hand, where the optical recording medium 1 includes the recording film 5, it is desirable to arrange a second thin film interference section between the super resolution film 4 and the recording film 5 or to arrange the third thin film interference section between the recording film 5 and the reflective film 6. Also, it is more desirable to arrange both second and third interference sections. A further optimization of the optical response can be achieved in this case, too.

It is possible for each of the second and third thin film interference sections to be formed of a single transparent thin film or a laminate structure of a plurality of transparent thin films. Where each of the second and third thin film interference sections is formed of a laminate structure of a plurality of transparent thin films, it is possible to allow the adjacent transparent thin films to be different from each other in the refractive index or in the characteristics other than the optical characteristics such as the hardness or weather resistance.

A recording-reproducing apparatus using the optical recording medium 1 described above will now be described.

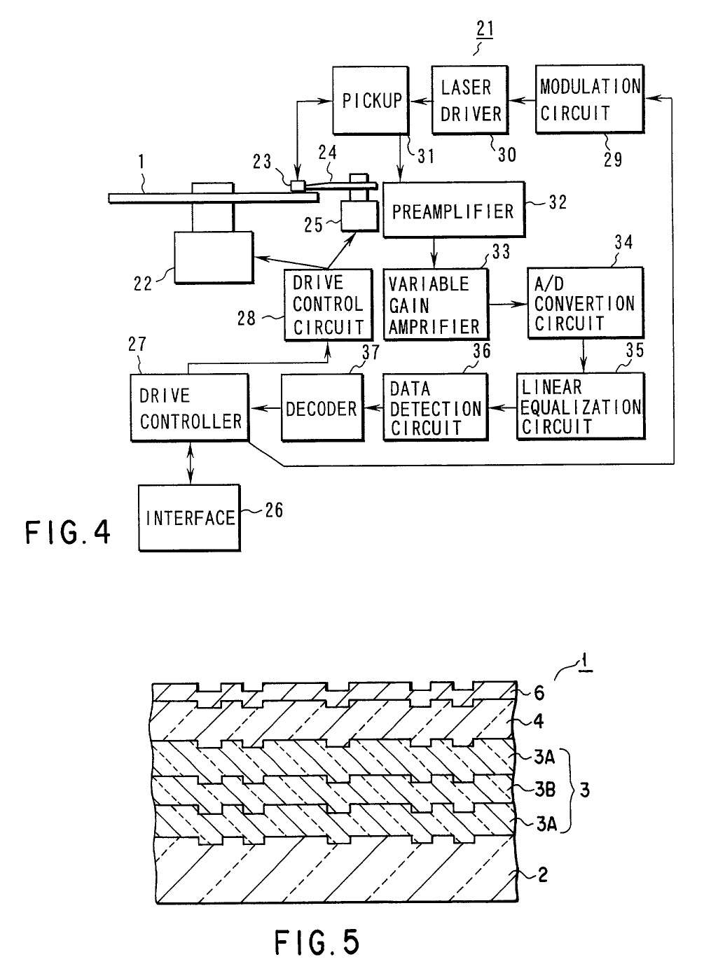

Specifically, FIG. 4 schematically shows a recording-reproducing apparatus 21 including the optical recording medium 1 shown in FIG. 1. As shown in the drawing, the recording-reproducing apparatus 21 has the optical recording medium 1, a spindle motor 22, an optical head 23, an arm 24, a linear motor 25, an interface 26, a drive controller 27, a drive control circuit 28, a modulation circuit 29, a laser driver 30, a pickup 31, a preamplifier 32, a variable gain amplifier 33, an A/D conversion circuit 34, a linear equalization circuit 35, a data detection circuit 36 and a decoder 37.

In the recording-reproducing apparatus 21 shown in FIG. 4, the optical recording medium 1 is in the form of an optical disk of a rewritable type, e.g., a phase change type, and is rotatably supported by a rotating shaft of the spindle motor 22 such that the substrate 2 of the optical disk 1 faces upward. The optical disk 1 is allowed to be rotated at a predetermined rotational speed by controlling the rotational speed of the spindle motor 22. The optical head 23 supported by one end of the arm 24 is arranged above the optical disk 1. The linear motor 25 is mounted to the other end of the arm 24 to permit the optical head 23 to be movable in the radial direction of the optical disk 1. These spindle motor 22 and the linear motor 25 are controlled by the drive controller 27 via the drive control circuit 28. The optical disk 1 is made movable relative to the optical head 23 by the driving mechanism of the particular construction described above.

In the recording-reproducing apparatus 21 shown in FIG. 4, the optical head 23, the modulation circuit 29, the laser driver 30 and the pickup 31 constitute a recording mechanism. The optical head 23 includes a light source such as a laser diode, and permits the optical disk 1 to be irradiated with the laser light emitted as a recording light from the laser diode. Also, the optical head 23 receives the light reflected from the optical disk 1 and guides the received light to a detection element. The modulation circuit 29 executes the coding process for converting the recording data transmitted from the drive controller 27 into a predetermined sign bit string. Further, the laser driver 30 drives the laser diode arranged within the pickup 31 so as to permit recording marks corresponding to the sign bit string outputted from the modulation circuit 29 to be formed in the recording film 5 of the optical disk 1.

In the recording-reproducing apparatus 21 shown in FIG. 4, the light detection system including the optical head 23 and the pickup 31 and a reproduced signal conditioning circuit constitute a reproducing mechanism. Incidentally, the reproduced signal conditioning circuit includes the preamplifier 32, the variable gain amplifier 33, the A/D conversion circuit 34, the linear equalization circuit 35, the data detection circuit 36 and the decoder 37. In addition to the laser diode, a detection element is also arranged within the pickup 31. In reading the information recorded in the recording film 5 of the optical disk 1, the optical disk 1 is irradiated via the optical head 23 with the laser light emitted from the laser diode of the pickup 31. The light reflected from the optical disk 1 is guided through the optical head 23 to the pickup 31. A detection element including a light detector is arranged in the pickup 31. The intensity of the reflected light or the reflectance, which is a ratio of the intensity of the reflected light to the intensity of the irradiating light, is detected by the detecting element.

The preamplifier 32 and the variable gain amplifier 33 serve to amplify the output signal from the detection element of the pickup 31. The A/D converter 34 serves to convert the signal amplified by the preamplifier 32 and the variable gain amplifier 33 into a digital signal. The linear equalization circuit 35 is a kind of a digital filter. The data detection circuit 36 is for example a signal processing circuit which estimates the sign bit string by a maximum likelihood (ML) method for detecting data from the waveform of the reproduced signal equalized by the partial response (PR). Further, the decoder 37 serves to bring the sign bit string detected by the data detection circuit 36 back to the original recording data.

The driving controller 27, which is a main control system of the recording-reproducing system shown in FIG. 4, is connected to, for example, a personal computer or an AV appliance via the interface 26 so as to control the transmission of the recording and reproducing data.

The recording-reproducing apparatus 21 has the optical disk 1 shown in FIG. 1, as already described. Therefore, the recording-reproducing apparatus 21 permits achieving a recording density higher than that in the prior art. Also, where the recording density of the recording-reproducing apparatus 21 is made substantially equal to that of the conventional apparatus, a difficulty such as crosstalk is unlikely to be produced. In other words, a read error is unlikely to take place. It follows that the operating margin can be widened.

Some Examples of the present invention will now be described.

### EXAMPLE 1

FIG. 5 is a cross sectional view schematically showing an optical recording medium 1 according to Example 1 of the present invention. The optical recording medium 1 shown in FIG. 5 is a ROM disk having pits formed as recording marks on one main surface of the transparent substrate 2 made of polycarbonate. The thin film interference section 3, the super resolution film 4 and the reflective film 6 are successively formed in the order mentioned on that surface of the transparent substrate 2 on which the pits are formed. Recessed portions corresponding to the pits formed on the surface of the substrate 2 are formed on each of these thin film interference section 3, super resolution film 4 and reflective film 6.

In the ROM disk 1, the interference light generated by the interference between the light reflected from the reflective film 6 and the light subjected to a multiple interference in the thin film interference section 3 is utilized as a reproducing light in the step of the light irradiation from the side of the transparent substrate 2 for reading information. In Example 1, the presence of the thin film interference section 3 makes it possible to increase a ratio of a signal, which represents the intensity of the reflected light from the optical opening, to a noise, which represents the intensity of the reflected light from the optical mask portion, i.e., an S/N ratio. The term “optical opening” noted above represents the portion where the light intensity has a value not lower than a predetermined value in curve 14 shown in FIG. 3B. On the other hand, the term “optical mask portion” noted above represents the portion where the light intensity is lower than the predetermined value in curve 14 shown in FIG. 3B.

Also, in the ordinary ROM disk, a reflective film is formed directly on a substrate, and information is read by irradiating the reflective film with light from the side opposite to the side of the substrate. In the ROM disk 1 of the present invention shown in FIG. 5, however, information is read by irradiating the reflective film 6 with light from the side of the substrate 2. As a result, the diameter of the incident light-beam is diminished by the thin film interference section 3 and the super resolution film 4 and, then, the incident light is reflected from the interface between the super resolution film 4 and the reflective film so as to be brought back to the detecting system. In other words, in the ROM disk 1 shown in FIG. 5, the information transferred from the surface of the transparent substrate 2 to the reflective film 6 is read in place of the information recorded on the surface of the transparent substrate 2.

The situations common with the construction employed in Example 1 will now be described in detail.

Specifically, in the ROM disk 1 of Example 1, the thin film interference section 3 has a laminate structure comprising a transparent thin films 3A, each of which is made of ZnS and has a refractive index of 2.35, and transparent thin films 3B, each of which is made of MgF₂ and has a refractive index of 1.4. These transparent thin films 3A and 3B are alternately stacked upon the other. In the ROM disk 1 shown in FIG. 5, three transparent thin films are stacked one upon the other. Incidentally, the refractive index noted above is based on the light having a wavelength λ of 410 nm. It is desirable for the thickness of each of the transparent thin films 3A and 3B to be λ/4n or in the vicinity of λ/4n, where n represents the refractive index of each of these transparent thin films. In Example 1, the thickness of the transparent thin film 3A is set at about 44 nm, and the thickness of the transparent thin film 3B is set at about 70 nm.

The super resolution film 4 is formed of a material having a refractive index of 1.7 and an extinction coefficient of substantially zero, i.e., less than 0.1, when the material is irradiated with light having a low intensity. The thickness of the super resolution film 4 is set at about 87 nm so as to minimize the reflectance of the ROM disk 1 when the super resolution film 4 has the refractive index noted above. Incidentally, the term “light having a low intensity” noted above represents the light component outside the FWHM (Full Width at Half Maxima) of the light (about 1 mW) used for reproducing the general optical disk. On the other hand, the term “light having a high intensity” used as a contrast to the “light having a low intensity” noted above represents the light component inside the FWHM of the light (about 1 mW) used for reproducing the general optical disk. It should be noted in this connection that it suffices to determine appropriately the power of the light used for reproducing the optical disk 1 in accordance with the power response characteristics of the super resolution film 4. In general, it is possible to set the power of the light to fall within a wide range of between about 0.3 mW and about 5 mW.

As the super resolution film 4 having the above-noted values of the complex refractive index when irradiated with a light having a low intensity, a film prepared by dispersing fine particles of a phase change material such as Ge—Sb—Te, Sb—Te and Sb in a transparent dielectric material so as to control the complex refractive index; a film prepared by dispersing a thermochromic material such as bianthrone and spiropyran in a solvent so as to control the complex refractive index; a film prepared by dispersing a photochromic material such as pyrobenzopyran, fulgide, diarylethene, cyclophane and azobenzene in a solvent so as to control the complex refractive index; a film having semiconductor fine particles dispersed therein and the like can be used. Such a super resolution film 4 can be prepared by, for example, a multi-source simultaneous sputtering method, a spin coating method or a co-vapor deposition method.

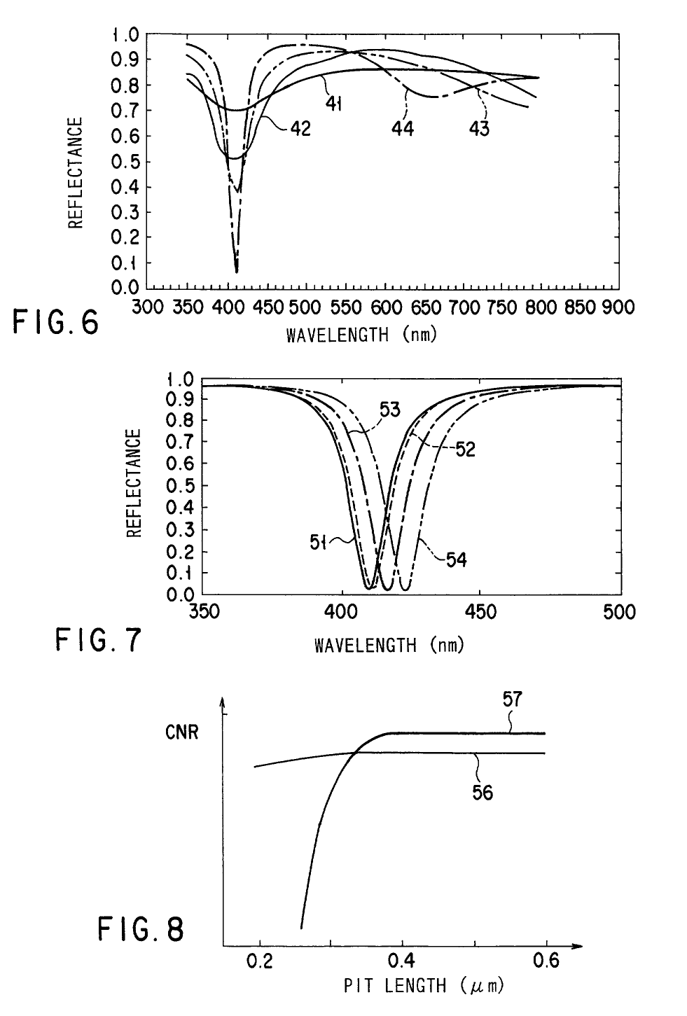

The reflection spectra were calculated in respect of a plurality of ROM disks 1 of the construction described above, the ROM disks 1 differing from each other in the construction of the thin film interference section 3. FIG. 6 shows the results.

Specifically, FIG. 6 is a graph showing the relationship between the construction of the thin film interference section 3 and the reflectance of the ROM disk 1. In the graph of FIG. 6, the wavelength of the light irradiating the ROM disk 1 is plotted on the abscissa, with the reflectance at the optical mask portion in the step of the light irradiation being plotted on the ordinate. Curves 41, 42, 43 and 44 are shown in the graph of FIG. 6. Curve 41 represents the data in the case where the thin film interference section 3 was formed of a single transparent thin film 3A alone (H). Curve 42 represents the data in the case where the thin film interference section 3 was prepared by stacking a single transparent thin film 3A and a single transparent thin film 3B one upon the other from the substrate 2 (HL). Curve 43 represents the data in the case where the thin film interference section 3 was prepared by allowing a single transparent thin film 3B to be sandwiched between two transparent thin films 3A (HLH). Further, curve 44 represents the data in the case where the thin film interference section 3 was prepared by alternately stacking three transparent thin films 3A and two transparent thin films 3A one upon the other (HLHLH).

As apparent from curve 41 shown in FIG. 6, where the thin film interference section 3 is formed of a single transparent thin film 3A alone, the reflectance in relation to the light (wavelength of 410 nm) used for reading information is substantially equal to the reflectance in relation to the light of the other wavelength region. On the other hand, where the thin film interference section 3 is formed of at least one transparent thin film 3A and at least one transparent thin film 3B, the reflectance in relation to the light having a wavelength of 410 nm is markedly lower than the reflectance in relation to the light having other wavelength region, as apparent from curves 42 to 44. This tendency is rendered prominent with increase in the number of transparent thin films 3A and 3B forming the thin film interference section 3. Incidentally, the reflectance was calculated by the known calculating method.

Then, the relationship between the refractive index and the reflectance of the super resolution film 4 was examined in respect of the ROM disk 1 shown in FIG. 5, in which the thin film interference section 3 was prepared by alternately laminating three transparent thin films 3A and two transparent thin films 3B (HLHLH).

FIG. 7 is a graph showing the relationship between the refractive index of the super resolution film 4 and the reflectance of the ROM disk 1. In the graph of FIG. 7, the wavelength of the light irradiating the ROM disk 1 is plotted on the abscissa, with the reflectance in the case of irradiating the light being plotted on the ordinate. Curves 51, 52, 53 and 54 are shown in the graph of FIG. 7. Curve 51 represents the date in the case where the refractive index of the super resolution film 4 was 1.7. Curve 52 represents the date in the case where the refractive index of the super resolution film 4 was 1.71. Curve 53 represents the date in the case where the refractive index of the super resolution film 4 was 1.75. Further, curve 54 represents the date in the case where the refractive index of the super resolution film 4 was 1.8. Incidentally, the super resolution film 4 was assumed such that, with increase in the intensity of the irradiating light, the real part of the complex refractive index would be increased, and the imaginary part of the complex refractive index would remain substantially unchanged and would be substantially zero.

As shown in FIG. 7, only a slight increase in the reflectance brings about a shift of the reflectance profile toward the long wavelength side with the steep shape kept maintained. When it comes to the reflectance with the light having a wavelength of 410 nm, which is used for reading information, the reflectance is increased by about 80% if the refractive index of the super resolution film 4 is increased to only 1.8, though the reflectance is only about 3% in the case where the refractive index of the super resolution film 4 is 1.7. This implies that it is possible to set the reflectance in the optical mask portion at about 3% and to set the reflectance in the optical opening portion at about 80%. In other words, it is possible to shield the information from the optical mask portion and to read selectively the information from the optical opening portion. The particular dependence of the reflectance on the light intensity well conforms with the dependency of the transmittance on the light intensity described previously in conjunction with FIG. 3B in the effect of diminishing the diameter of the light-beam, though there is a difference in wording between the transmittance and the reflectance.

The shift of the reflectance profile described in conjunction with FIG. 7 also takes place in the case where the thin film interference section 3 is formed of a single transparent thin film 3A alone, as apparent from curve 41 shown in FIG. 6. In this case, however, the reflectance does not exhibit a steep change in accordance with the change in the wavelength. Therefore, even if the refractive index of the super resolution film 4 is changed to some extent, the reflectance with the light having a wavelength of 410 nm, which is used for reading information, is scarcely changed. In other words, it is impossible to obtain a sufficient super resolution effect.

In order to obtain a sufficient super resolution effect, it is necessary for the thin film interference section 3 to be formed of at least two transparent thin films 3A, 3B, and it is desirable to employ a laminate structure of at least three transparent thin films laminated one upon the other such that the adjacent transparent thin films differ from each other in the refractive index. In general, the upper limit in the number of transparent thin films that are laminated one upon the other is determined such that the thickness of the laminated structure does not exceed the focal depth of the light-beam.

In order to obtain a large super resolution effect, it is necessary to employ the laminate structure of the thin film interference section 3 and the super resolution film 4. In addition, it is desirable to determine appropriately the thickness, the refractive index, the stacking order, and the number of films stacked in the thin film interference section 3 as well as the refractive index and the thickness of the super resolution film 4 such that the reflectance assumes the lowest value when irradiated with any one of the light having a low intensity and the light having a high intensity, as apparent from FIG. 7. It should be noted, however, that, in order to obtain a larger super resolution effect, it is desirable for the super resolution film 4 to have a large thickness within the focal depth of the light-beam. Such being the situation, it is not desirable to limit the thickness of the super resolution film 4 in an attempt to achieve the reflectance described above. In other words, it is desirable to increase the design flexibility.

In order to increase the design flexibility, it is effective to arrange the second thin film interference section referred to previously between the super resolution film 4 and the reflective film 6. The presence of the second thin film interference section makes it possible to realize the reflectance described above without limiting the thickness of the super resolution film 4.

### EXAMPLE 2

The ROM disk 1 shown in FIG. 5 was prepared as in Example 1, except that the thin film interference section 3 of the ROM disk 1 was prepared by alternately laminating three transparent thin films 3A and two transparent thin films 3B (HLHLH). In Example 2, the material and thickness of each of the thin films were set as follows so as to obtain the highest super resolution effect in the case of reading information by using light having a wavelength λ of 413 nm.

Specifically, a polycarbonate substrate was used as the transparent substrate 2, and pits each having a length of 0.2 μm to 0.6 μm were formed as recording marks on one main surface of the transparent substrate 2. Each of the transparent thin films 3A was formed of ZnS having a refractive index of 2.4 and the thickness of which was set at 68.3 nm so as to obtain an optical film thickness of λ/4. On the other hand, each of the transparent thin film 3B was formed of SiO₂ having a refractive index of 1.5, and the thickness of which was set at 42.7 nm so as to obtain an optical film thickness of λ/4. The super resolution film 4 was formed of a material having a refractive index n of 1.7 and an extinction coefficient k of approximately zero when irradiated with light having a low intensity, the refractive index n of which being change to 1.8 and the attenuation coefficient k remaining substantially unchanged when irradiated with light having a high intensity. Also, the thickness of the super resolution film 4 was set at 74 nm so as to minimize the reflectance of the ROM disk 1 in the initial state in which the disk 1 is not irradiated with light. Further, the reflective film 6 was formed of AlTi and the thickness of the reflective film 6 was set at 100 nm.

For comparison, an additional ROM disk was prepared as above, except that the thin film interference section 3 was not included in the ROM disk for the comparative case.

The dependence of the CNR (Carrier to Noise Ratio) value on the pit length was examined by using a reproduction evaluation machine having a Kr⁺ gas laser as a light source in respect of the ROM disk 1 prepared in Example 2 and the ROM disk for the comparative case. Incidentally, the reproducing wavelength was set at 413 nm and the reproducing power was set at 1 mW in the reproduction evaluation machine. FIG. 8 shows the results.

FIG. 8 is a graph showing the relationship between the pit length and the CNR value in respect of the ROM disk 1 prepared in Example 2 and the ROM disk for the comparative case. In the graph of FIG. 8, the pit length is plotted on the abscissa, with the CNR value being plotted on the ordinate. Curve 56 shown in FIG. 8 represents the data obtained in respect of the ROM disk 1 prepared in Example 2. Also, curve 57 shown in FIG. 8 represents the data obtained in respect of the ROM disk for the comparative case.

As apparent from FIG. 8, when it comes to the ROM disk for the comparative case, the CNR value is large where the pit length is not shorter than 0.4 μm. However, the CNR value is rapidly decreased where the pit length is less than 0.4 μm. The particular CNR profile is derived from the fact that, in the ROM disk for the comparative case, it is impossible to obtain a sufficient super resolution effect. On the other hand, the ROM disk 1 for Example 2 of the present invention permits maintaining a high CNR value even if the pit length is only about 0.2 μm. The results clearly support that the thin film interference section 3 is highly effective for improving the characteristics of the super resolution film 4.

### EXAMPLE 3

The ROM disk 1 was prepared as in Example 2, except that a second thin film interference section was formed between the super resolution film 4 and the reflective film 6 and that the thickness of the super resolution film 4 was set at 300 nm. It should be noted that Example 3 was intended to support that, if the second thin film interference section is arranged, it is possible to increase the thickness of the super resolution film 4, i.e., it is possible to increase the optical path, making it possible to obtain a higher super resolution effect. Incidentally, in Example 3, the second thin film interference film was formed of a single layer of an AlN film having a refractive index of 1.8. Also, the thickness of the second thin film interference section was set at 100 nm in order to minimize the reflectance when irradiated with light having a low intensity.

The dependence of the CNR value on the pit length was also examined for the ROM disk 1 as in Example 2. It was possible to obtain a CNR value and a super resolution effect higher than those obtained in Example 2.

### EXAMPLE 4

In Examples 1 to 3 described above, the present invention is applied to an optical recording medium of read-only type. On the other hand, Example 4 is directed to a rewritable type optical recording medium.

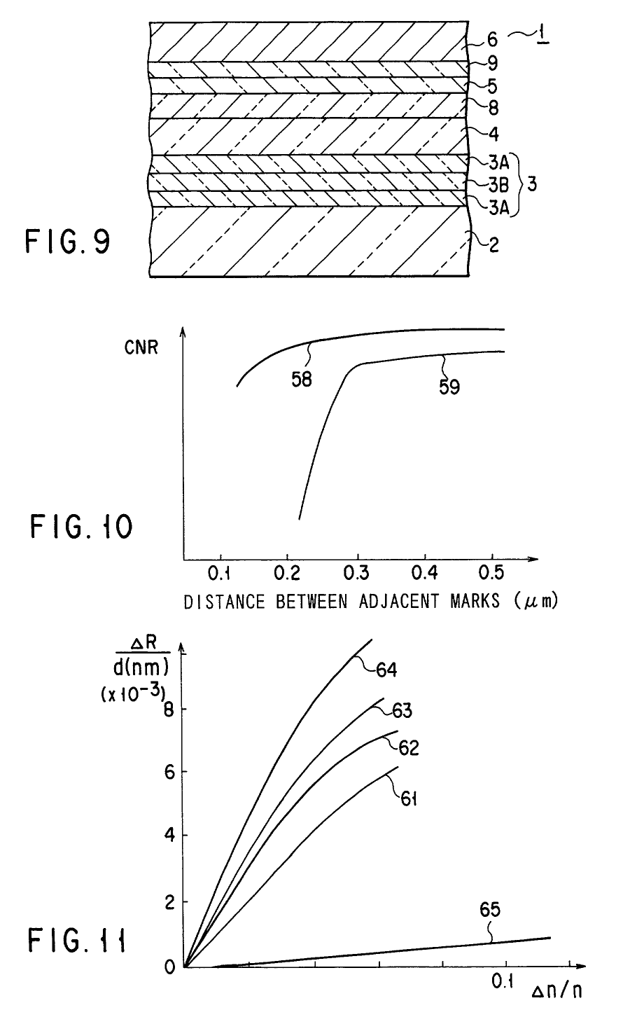

Specifically, FIG. 9 is a cross sectional view schematically showing the optical recording medium 1 according to Example 4 of the present invention. The optical recording medium 1 shown in FIG. 9 is a phase change type optical disk, and has a transparent substrate 2 made of polycarbonate and provided with a spiral groove or concentric grooves on one main surface thereof. On the surface of the transparent substrate 2 on which the groove(s) is formed, the first thin film interference section 3, the super resolution film 4, the second thin film interference section 8, the recording film 5, a third thin film interference section 9 and the reflective film 6 are stacked successively. The first thin film interference section 3 is prepared by allowing a single transparent thin film 3B to be sandwiched between two transparent thin films 3A. On the other hand, each of the second and third thin film interference sections 8 and 9 is of a single layer structure.

In Example 4, each of the transparent thin films 3A was formed of TiO₂ having a refractive index of 2.5, and the transparent thin film 3B was formed of MgF₂ having a refractive index of 1.2. Also, the thickness of each transparent thin film 3A was set at 40 nm and the thickness of the transparent thin film 3B was set at 85 nm so as to provide the quenching state when irradiated with light having a wavelength of 405 nm. The super resolution film 4 was formed of a material having a refractive index n of 2.3 and an extinction coefficient k of approximately zero when irradiated with light having a low intensity, the refractive index n of which being increased to 2.4 and the attenuation coefficient k remaining substantially unchanged when irradiated with light having a high intensity. Also, the thickness of the super resolution film 4 was set at 100 nm. The recording film 5 was formed of Ge—Sb—Te, and each of the second and third thin film interference sections 8 and 9 was formed of ZnS—SiO₂. Also, the reflective film 6 was formed of AgPdCu and the thickness of the reflective film 6 was set at 100 nm. Incidentally, in the optical disk 1, the second and third thin film interference sections 8 and 9 serve to enhance the design flexibility and also serve to enhance the change in reflectance of the recording film 5. Also, these second and third thin film interference sections 8 and 9 act as protective films serving to prevent the light irradiated portion from being evaporated when the recording film 5 is irradiated with light.

For comparison, an additional optical disk of a phase change type was prepared as above, except that the optical disk for the comparative case did not include the thin film interference section 3.

The dependence of the CNR value referred previously on the distance between adjacent recording marks was examined by using a recording-reproducing evaluation machine having a semiconductor laser with a wavelength of 405 nm as a light source in respect of the phase change type optical disk 1 prepared in Example 4 and the phase change type optical disk for the comparative case. Incidentally, in recording information on the optical disk 1, recording marks each having a length of 0.3 μm were formed in the recording film 5 with a single frequency while changing the distance between adjacent recording marks. During the information recording, the optical disk 1 was rotated at a linear speed of 6 m/s and the recording power was set at 9 mW. Also, the information recorded on the optical disk 1 was reproduced with a power of 1 mw while rotating the optical disk at a linear speed of 6 m/s. FIG. 10 shows the results.

Specifically, FIG. 10 is a graph showing the relationship between the distance between adjacent recording marks and the CNR value in respect of the phase change type optical disk 1 for Example 4 of the present invention and the phase change type optical disk for the comparative case. In the graph of FIG. 10, the distance between adjacent recording marks is plotted on the abscissa, with the CNR value being plotted on the ordinate. Curve 58 shown in FIG. 10 represents the data obtained in respect of the phase change type optical disk 1 for Example 4 of the present invention. On the other hand, curve 59 shown in FIG. 10 represent the data in respect of the phase change type optical disk for the comparative case.

As apparent from FIG. 10, in the phase change type optical disk for the comparative case, the CNR value is large in the case where the distance between adjacent recording marks is not smaller than 0.3 μm. However, the CNR value is rapidly decreased in the case where the distance between adjacent recording marks is smaller than 0.3 μm. The particular phenomenon is brought about by the fact that a strong interference is generated between adjacent recording marks. Also, in the phase change type optical disk for the comparative case, there is a large crosstalk from the adjacent track, with the result that the CNR value is not appreciably increased even where the distance between adjacent recording marks is large.

On the other hand, when it comes to the phase change type optical disk 1 for Example 4 of the present invention, a high CNR value is maintained even if the distance between adjacent recording marks is small, i.e., about 0.15 μm. Also, crosstalk is unlikely to take place in the phase change type optical disk 1 for Example 4 of the present invention, making it possible to realize a CNR value markedly higher than that of the phase change type optical disk for the comparative case.

Incidentally, in Example 4 of the present invention, a phase change type recording film was used as the recording film 5. However, it is also possible to use a magneto-optical recording film or a dye recording film as the recording film 5. In this case, it is possible to obtain the effect similar to that described above.

### EXAMPLE 5

The optical disk 1 shown in FIG. 5 were prepared, though the materials of the super resolution film 4 were changed in several fashions. In each of these optical disks 1, the super resolution film 4 was formed of an optical material in which the refractive index n is changed in accordance with the intensity of the irradiating light with the extinction coefficient k, which is zero, left substantially unchanged. Then, the reflectance in the case of irradiation with light having a low intensity and the reflectance in the case of irradiation with light having a high intensity were measured in respect of each of these optical disks 1. FIG. 11 shows the result.

Specifically, FIG. 11 is a graph showing the effect given by the thin film interference section 3 to the reflectance of the optical disk 1. In the graph of FIG. 11, plotted on the abscissa is the value of Δn/n_{L}, where Δn represents the difference between the refractive index n_{H} in the case where the super resolution film 4 is irradiated with light having a high intensity and the refractive index n_{L} in the case where the super resolution film 4 is irradiated with light having a low intensity, and n_{L} represents the refractive index as noted above. On the other hand, plotted on the ordinate of the graph of FIG. 11 is the value of ΔR/d, where ΔR represents the difference between the reflectance R_{L} in the case of irradiating the disk 1 with light having a low intensity and the reflectance RH in the case of irradiating the disk 1 with light having a high intensity, and d represents the thickness (nm) of the super resolution film 4. Curves 61 to 65 are shown in the graph of FIG. 11. It should be noted that curves 61 to 64 represent the data in the cases where materials exhibiting the refractive indices n_{L}, when irradiated with light having a low intensity, of 1.4, 1.7, 2.3 and 3.5, respectively, were used for forming the super resolution film 4. On the other hand, curve 65 in FIG. 11 represents the data on an optical disk equal in construction to the optical disks of Example 5, except that the thin film interference section 3 was not formed in the optical disk and that the refractive index n_{L} of the super resolution film 4 was about 2.

As apparent from FIG. 11, it is possible to obtain ΔR/d that is at least two times as large as that in the case where the thin film interference section 3 is not formed by setting the value of (ΔR/d)/(Δn/n_{L}) at 6.7×10⁻³ or more. To be more specific, it is possible to obtain a sufficient super resolution effect even in the case of using a material having a small value of An for forming the super resolution film 4 by constructing the optical disk 1 to meet the relationship represented by the inequality given below:

Δn/n_{L}≦150×(|R_{H}−R_{L})/d

Also, in the case of using a material having a large value of Δn for forming the super resolution film 4, it is possible to obtain a further excellent super resolution effect.

### EXAMPLE 6

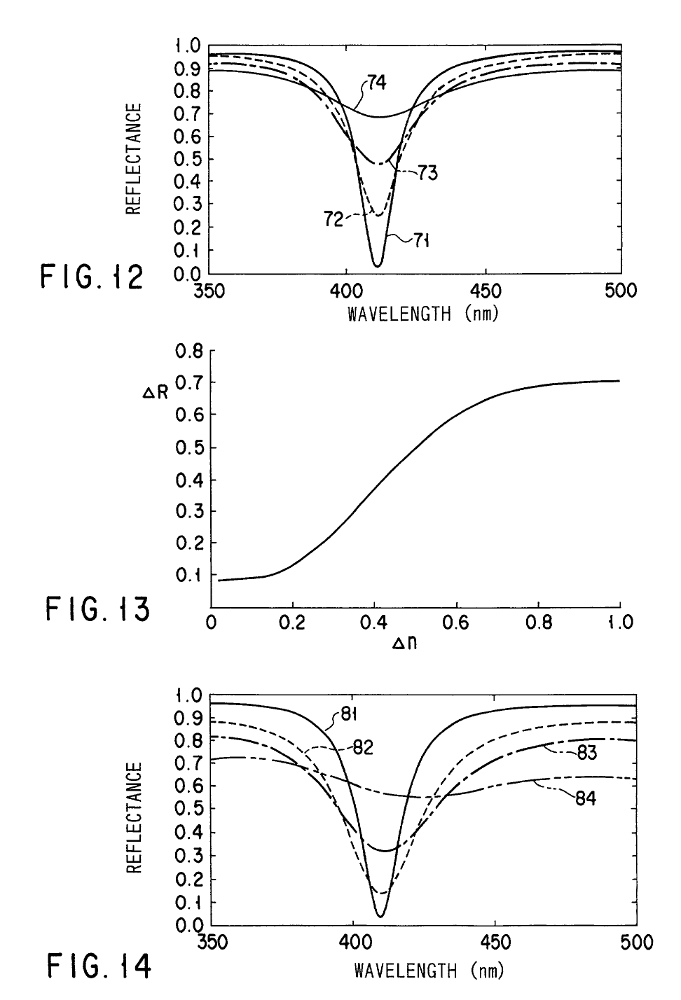

The optical disks 1 shown in FIG. 5 were prepared, though the refractive index of the transparent thin film 3B was set at 1.5 and the refractive index of the transparent thin film 3A was changed in several fashions. The dependence of the reflectance in the case of irradiation with light having a high intensity on the wavelength was examined in respect of each of these optical disks 1. FIG. 12 shows a part of the results.

Specifically, FIG. 12 is a graph showing the relationship between the refractive index of the transparent thin film 3A and the reflectance of the optical disk 1. The wavelength of the light irradiating the optical disk is plotted on the abscissa of the graph, with the reflectance when irradiated with the light being plotted on the ordinate. Curves 71 to 74, which are shown in the graph of FIG. 12, represent the data covering the cases where the refractive indices of the transparent thin films 3A were 2.3, 2.1, 1.9 and 1.7, respectively. As shown in FIG. 12, the reflectance profile is made steeper with increase in the difference between the refractive index of the transparent thin film 3A and the refractive index of the transparent thin film 3B.

Then, the difference AR between the reflectance R_{L} of the disk 1 in the case of irradiation with light having a low intensity and the reflectance R_{H} of the disk 1 in the case of irradiation with light having a high intensity was obtained. The wavelength of the irradiating light was 410 nm. FIG. 13 shows the results.

Specifically, FIG. 13 is a graph showing the relationship between the difference ΔR in the reflectance of the optical disk 1 and the difference An in the refractive index between the transparent thin film 3A and the transparent thin film 3B. In the graph of FIG. 13, the difference An in the refractive index is plotted on the abscissa, with the difference AR in the reflectance being plotted on the ordinate. As shown in FIG. 13, the difference AR in the reflectance is increased prominently with increase in the difference Δn in the refractive index in the case where the difference Δn in the refractive index falls within a range of between 0.2 and 0.6. However, the difference ΔR in the reflectance is substantially saturated if the difference Δn in the refractive index is increased to 0.6 or higher. It follows that it is desirable for the difference Δn in the refractive index to be not smaller than 0.2, more desirably, not smaller than 0.6.

### EXAMPLE 7

In each of Examples 1 to 6, the super resolution film 4 is formed of a material in which the real part of the complex refractive index is changed in accordance with the intensity of the irradiating light, with the imaginary part of the complex refractive index left substantially unchanged. In Example 7, however, the super resolution film 4 is formed of a material in which the imaginary part of the complex refractive index is changed in accordance with the intensity of the irradiating light.

Specifically, in Example 7, the optical disk 1 shown in FIG. 5 was formed except that, the thin film interference section 3 was prepared by alternately stacking three transparent thin films 3A and three transparent thin films 3B (LHLHLH). In Example 7, each of the transparent thin films 3A was formed of SiO₂ and the thickness of each film 3A was set at λ/4n or in the vicinity of λ/4n, where λ is 410 nm and n is 1.5. On the other hand, each of the transparent thin films 3B was formed of ZnS, and the thickness of each film 3B was set at λ/4n or in the vicinity of λ/4n, where λ is 410 nm and n is 2.4. Further, in Example 7, the super resolution film 4 was formed of a material having a refractive index n of 2.3 and an extinction coefficient k of 0 when irradiated with light having a low intensity, the extinction coefficient k being increased to 0.5 and the refractive index n being left unchanged at 2.3 when irradiated with light having a high intensity. The super resolution film 4 is, for example, a semiconductor film or a semiconductor fine particle dispersion film. In the case of using such a film, the super resolution film 4 exhibiting changes in the complex refractive index as described above can be obtained by increasing the optical concentration, compared with the system in which the refractive index n is changed in accordance with intensity of the irradiating light. Also, another material is used for forming the super resolution film 4, it is possible to obtain the super resolution film 4 which exhibits changes in the complex refractive index as noted above by, for example, decreasing the amount of the solvent.

FIG. 14 is a graph showing the relationship between the intensity of the irradiating light and the reflectance in respect of the optical disk 1. In the graph of FIG. 14, the wavelength of the irradiating light is plotted on the abscissa, with the reflectance of the optical disk 1 being plotted on the ordinate. Curves 81 to 84 shown in the graph of FIG. 14 represent the data covering the cases where the intensity of the irradiating light was controlled to permit the super resolution films 4 irradiated with light having a wavelength of 410 nm to exhibit the extinction coefficients of 0, 0.1, 0.2 and 0.5, respectively.

Focusing attention on the reflectance in the case of irradiation with light having a wavelength of about 410 nm, the reflectance is only about 5% when irradiated with light having a low intensity, i.e., where the extinction coefficient k is zero. On the other hand, the reflectance is increased to reach about 60% when irradiated with light having a high intensity, i.e., where the extinction coefficient k is 0.5. It follows that it is possible to obtain a sufficient super resolution effect in the optical disk 1 of Example 7.

Also, focusing attention on the reflectance in the case of irradiation with light having a wavelength of about 420 nm, the reflectance obtained when irradiated with light having a low intensity is higher than the reflectance obtained when irradiated with light having a high intensity. What should be noted is that the relation between reflectances in the case of irradiation with light having a wavelength of about 420 nm is opposite to that in the case of irradiation with light having a wavelength of about 410 nm. This clearly supports that it is possible to obtain a super resolution effect by setting appropriately the wavelength of the irradiating light even in the case where the super resolution film 4 is formed of a material whose extinction coefficient k is decreased by increasing the intensity of the irradiating light. Incidentally, it is possible to cause a shift of the reflectance profile shown in FIG. 14 toward the short wavelength side or long wavelength side by controlling the laminate structure employed in the optical disk 1 as well as the thickness and refractive index of each of the various thin films, as described previously in conjunction with FIG. 7. It follows that, if such a control is performed, it is possible to obtain a sufficient super resolution effect by using the light having a suitable wavelength, which is used in general, even in the case where the super resolution film 4 is formed of an optical material whose extinction coefficient k is decreased by increasing the intensity of the irradiating light.

As described above, the present invention makes it possible to obtain a sufficient super resolution effect in both causes where the super resolution film 4 is formed of an optical material whose refractive index n or extinction coefficient k is increased by increasing the intensity of the irradiating light and where the super resolution film 4 is formed of an optical material whose refractive index n or extinction coefficient k is decreased by increasing the intensity of the irradiating light. Similarly, a sufficient super resolution effect can be obtained in the case where the super resolution film 4 is formed of an optical material in which both the refractive index n and the extinction coefficient k are changed by increasing the intensity of the irradiating light. In other words, the present invention makes it possible for an optical material whose complex index of refraction is changed by increasing the intensity of the irradiating light to be used as the material for forming the super resolution film 4 even if the amount of change is small.

As described above, a super resolution film and a thin film interference section are used in combination in the present invention, making it possible to obtain a very high super resolution effect. Therefore, according to the present invention, it is possible to realize a recording density higher than that in the prior art. Also, where the recording density is made equal to that in the prior art, the present invention permits suppressing a read error. Further, the present invention makes it possible for the super resolution film to be formed of an optical material whose complex refractive index is changed slightly by increasing the intensity of the irradiating light.

To reiterate, the present invention provides an optical recording medium and a recording-reproducing apparatus capable of achieving a high recording density. The present invention also provides an optical recording medium and a recording-reproducing apparatus that are unlikely to give rise to a read error. Further, the present invention provides an optical recording medium and a recording-reproducing apparatus that make it possible to use a material whose optical constant is changed slightly by the light irradiation for forming a super resolution film.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical recording medium, comprising:
a substrate;
a reflective film provided on said substrate and having a recessed portion or a projecting portion as a recording mark on a surface thereof;
a super resolution film made of an optical material whose complex refractive index is changed in accordance with an intensity of a light irradiating said super resolution film; and
a first thin film interference section consisting of a plurality of transparent thin films, said plural transparent thin films being stacked one another, each two of said plural transparent thin films adjacent to each other being different from each other in refractive index, and said super resolution film and said first thin film interference section forming a laminate structure between said substrate and said reflective film or on the reflective film.

2. The optical recording medium according to claim 1, wherein said super resolution film is interposed between said first thin film interference section and said reflective film.

3. The optical recording medium according to claim 2, further comprising a second thin film interference section consisting of at least one transparent thin film and interposed between said super resolution film and said reflective film.

4. The optical recording medium according to claim 1, wherein a number of the transparent thin films constituting said first thin film interference section is at least three.

5. The optical recording medium according to claim 1, wherein each two of said plural transparent thin films adjacent to each other are different from each other in refractive index by at least 0.2.

6. The optical recording medium according to claim 1, wherein each of said plural transparent thin films constituting said first thin film interference section substantially satisfies a relationship represented by an equation given below:
d=λ/4n+m×λ/n
where d denotes a thickness of one of said plural transparent thin films, n denotes a refractive index of said transparent thin film, λ denotes a wavelength of the light, and m denotes 0 or natural number.

7. The optical recording medium according to claim 1, wherein real part n of the complex refractive index of said optical material is higher than imaginary part k of the complex refractive index of the optical material in a rate of change relative to the intensity of the light.

8. The optical recording medium according to claim 7, wherein said medium satisfies a relationship denoted by an inequality given below:

|n₂−n₁|/n₁≦150×|R₂−R₁|/d
where n₁ denotes a real part of the complex refractive index of said optical material when irradiated with light having a first intensity, n₂ denotes a real part of the complex refractive index of said optical material when irradiated with light having a second intensity higher than said first intensity, d denotes a thickness (nm) of said super resolution film, R₁ denotes a reflectance of said medium when the complex refractive index of said optical material has the real part n₁, and R₂ denotes a reflectance of said medium when the complex refractive index of said optical material has the real part n₂.

9. The optical recording medium according to claim 1, wherein real part n of the complex refractive index of said optical material is lower than imaginary part k of the complex refractive index of the optical material in a rate of change relative to the intensity of the light.

10. An optical recording medium, comprising:
a substrate;
a reflective film provided on said substrate;
a super resolution film made of an optical material whose complex refractive index is changed in accordance with an intensity of a light irradiating said super resolution film;
a first thin film interference section consisting of a plurality of transparent thin films, said plural transparent thin films being stacked one another, each two of said plural transparent thin films adjacent to each other being different from each other in refractive index, and said super resolution film and said first thin film interference section forming a laminate structure between said substrate and said reflective film or on the reflective film; and
a recording film provided between said laminate structure and said reflective film.

11. The optical recording medium according to claim 10, wherein said super resolution film is interposed between said first thin film interference section and said reflective film.

12. The optical recording medium according to claim 11, further comprising a second thin film interference section consisting of at least one transparent thin film and interposed between said super resolution film and said reflective film and a third thin film interference section consisting of at least one transparent thin film and interposed between said recording film and said reflective film.

13. The optical recording medium according to claim 10, wherein a number of the transparent thin films constituting said first thin film interference section is at least three.

14. The optical recording medium according to claim 10, wherein each two of said plural transparent thin films adjacent to each other are different from each other in refractive index by at least 0.2.

15. The optical recording medium according to claim 10, wherein each of said plural transparent thin films constituting said first thin film interference section substantially satisfies a relationship represented by an equation given below:
d=λ/4n+m×λ/n
where d denotes a thickness of one of said plural transparent thin films, n denotes a refractive index of the transparent thin film, λ denotes a wavelength of the light, and m denotes 0 or natural number.

16. The optical recording medium according to claim 10, wherein real part n of the complex refractive index of said optical material is higher than imaginary part k of the complex refractive index of the optical material in a rate of change relative to the intensity of the light.

17. The optical recording medium according to claim 16, wherein said medium satisfies a relationship denoted by an inequality given below:

|n₂−n₁|/n₁≦150×|R₂−R₁|/d
where n₁ denotes a real part of the complex refractive index of said optical material when irradiated with light having a first intensity, n₂ denotes a real part of the complex refractive index of said optical material when irradiated with light having a second intensity higher than said first intensity, d denotes a thickness (nm) of said super resolution film, R₁ denotes a reflectance of said medium when the complex refractive index of said optical material has the real part n₁, and R₂ denotes a reflectance of said medium when the complex refractive index of said optical material has the real part n₂.

18. The optical recording medium according to claim 10, wherein real part n of the complex refractive index of said optical material is lower than imaginary part k of the complex refractive index of the optical material in a rate of change relative to the intensity of the light.

19. A recording-reproducing apparatus, comprising:
an optical recording medium comprising a substrate, a reflective film provided on said substrate, a super resolution film made of an optical material whose complex reflective index is changed in accordance with an intensity of a light irradiating said super resolution film, a first thin film interference section consisting of a plurality of transparent thin films, said plural transparent thin films being stacked one another, each two of said plural transparent thin films adjacent to each other being different from each other in refractive index, and said super resolution film and said first thin film interference section forming a laminate structure between said substrate and said reflective film or on the reflective film, and a recording film provided between said laminate structure and said reflective film;
a recording mechanism configured to irradiate said recording film with a recording light so as to form recording marks corresponding to information to be recorded in the recording film; and
a reproducing mechanism configured to irradiate the recording film with light and detect the light reflected from the optical recording medium so as to reproduce the information recorded as said recording marks in the recording film.

20. The recording-reproducing apparatus according to claim 19, wherein each of said plural transparent thin films constituting said first thin film interference section substantially satisfies a relationship represented by an equation given below:
d=λ/4n+m×λ/n
where d denotes a thickness of one of said transparent thin film, n denotes a refractive index of said transparent thin film, λ denotes a wavelength of the light, and m denotes 0 or natural number.
